(19) United States
(12) Patent Application Publication
(10) Pub. No.: US 2017/0113745 A1
(43) Pub. Date: Apr. 27, 2017

(54) MAP-BASED VEHICLE RIDE HEIGHT CONTROL

(71) Applicant: International Truck Intellectual Property Company, LLC, Lisle, IL (US)

(72) Inventors: Anthony J. Cook, Geneva, IL (US); Darren William Gosbee, Maple Park, IL (US)

(73) Assignee: International Truck Intellectual Property Company, LLC, Lisle, IL (US)

(21) Appl. No.: 14/919,230

(22) Filed: Oct. 21, 2015

(51) Int. Cl. B62D 65/12; B60W 30/095; B60G 99/00

(52) U.S. Cl. CPC B62D 65/12; B60G 99/002; B60W 30/0956; B60G 2300/044; B60G 2400/252; B60G 2400/95; B60G 2401/16; B60G 2500/30; B60G 2600/704; B60G 2800/914; B60G 2800/925

(57) ABSTRACT

A ride height adjustment of a vehicle traveling along a roadway is controlled by a controller which uses data about overpass clearances and the height of the highest point on the vehicle to lower vehicle height when the height can be lowered sufficiently to avoid collision with an overpass.

### TECHNICAL FIELD

This disclosure relates to vehicles whose ride height can be set to a desired setting within a range of settings.

### BACKGROUND

Ride height of a vehicle which travels on a roadway is commonly defined as the vertical distance, when the vehicle is at rest, between a vehicle's chassis frame and an axle which is suspended from the chassis frame by a suspension. That portion of the vehicle's weight which is transmitted through the suspension to the axle, and ultimately to an underlying road surface via pneumatically inflated tires of road wheels at ends of the axle, determines the extent to which the suspension is flexed, and hence determines the vehicle's ride height. Inflation pressure of those tires affects the vertical distance of the axle from the underlying road surface.

A vehicle may have a ride height adjustment system associated with one or more of its axles. One example of this is a highway tractor which has a rear drive axle, either a single drive axle or a tandem drive axle, suspended from a chassis frame. The single drive axle may be accompanied by a tag axle. A fifth wheel is supported on the chassis frame over the rear axle. When the kingpin of a trailer is coupled to the fifth wheel, the tractor can tow the trailer. A portion of the trailer weight is borne by the tractor at a location over the tractor's rear drive axle. The greater that weight, the more the underlying suspension is flexed and the ride height reduced. A ride height adjustment system associated with the rear drive axle can set the ride height to counter, either in whole or in part, the reduction in ride height caused by the portion of the trailer weight borne by the tractor.

One type of ride height adjustment system uses air bags associated with an axle's suspension system as the mechanism for adjustment. The ride height system is operable to increase ride height by increasingly filling the air bags with compressed air from a source which is commonly available when the tractor has air brakes. The system decreases ride height by venting compressed air from the air bags. A ride height sensor may be associated with a ride height adjustment system and used to accurately set ride height to a desired ride height within a range of ride heights extending from a minimum limit to a maximum limit.

During travel of a tractor-trailer along a roadway, ride height may be changed for any of various reasons. One reason is to render the tractor-trailer more aerodynamic, thereby reducing aerodynamic drag.

A ride height adjustment system may include a driver input which enables a driver of the tractor to set a desired ride height.

When a vehicle has an on-board deflation/inflation system for inflatable pneumatic tires of road wheels at ends of one or more axles, inflation pressure of those tires can be changed to lower or raise an axle relative to an underlying road surface, and accordingly an on-board tire deflation/inflation system may be considered as part of a ride height adjustment system.

### SUMMARY OF THE DISCLOSURE

This disclosure introduces a system and method for utilizing any ride height adjustment system in conjunction with data representing vertical distance from the highest point on the vehicle to an underlying road surface and data in a data base of vertical clearances of geographic features, and structures such as overpasses and tunnels, to an underlying road surface along a roadway to identify those features and structures which provide sufficient clearance to assure that the vehicle can pass under or through without colliding with the overlying feature or structure and to identify other features and structures which do not provide sufficient clearance.

Identification is made by a processor which for the particular setting to which a ride height adjustment system is set, evaluates vertical distance from the highest point on a vehicle to the underlying road surface with respect to vertical clearance of each geographic feature and structure beneath which the vehicle will pass during travel along a defined travel route on a roadway. If a particular geographic feature or structure is found to provide insufficient clearance and the particular setting of a ride height adjustment system would allow further reduction in ride height, it becomes possible to determine if an available reduction would be sufficient to assure that the vehicle can pass under the particular feature or structure without collision. If so, appropriate adjustment can be made and the original travel route need not be modified to avoid the feature or structure; otherwise an alternate travel route which bypasses the feature or structure can be chosen.

Certain information about a vehicle is used in order to identify the highest point of the vehicle above an underlying road surface. In the case of a tractor-trailer, the vertical distance from the highest point on the trailer to an underlying road surface may be greater than the vertical distance from the highest point on the tractor to an underlying surface. Alternately that of the tractor may be greater. Hence the configuration and dimensional parameters of a particular tractor and those of a particular trailer have a bearing on whether the highest point is on the tractor or the trailer.

A tractor typically has a cab whose roof may not necessarily contain the highest point on the tractor. For example, devices or equipment may be mounted on the roof, or a vertical exhaust pipe on the exterior of the cab may extend higher than the roof. The trailing edge of a roof-mounted aerodynamic wind deflector on a tractor may extend higher than the leading edge of the roof of a trailer coupled to the tractor, or alternately, the leading edge of the trailer roof may extend higher.

The vertical distance from the highest point to an underlying road surface is also a function of the setting of the ride height adjustment system. The vertical distance is a minimum at a minimum limit of a range of settings of the ride height adjustment system and a maximum at a maximum limit of the range.

A general aspect of the disclosure relates to a vehicle comprising a chassis frame, road wheels on which the vehicle travels along an underlying roadway surface, suspensions which suspend the road wheels from the chassis frame, a ride height adjustment system for setting vertical distance from the chassis frame to an underlying roadway surface to a setting within a range of settings extending from a minimum limit to a maximum limit, a controller for operating the ride height adjustment system to a setting within the range, and a processor which evaluates: 1) data representing a setting to which the ride height adjustment system was set while the vehicle was stationary, 2) data representing vertical distance from the highest point anywhere on the vehicle to an underlying roadway surface for the setting to which the ride height adjustment system was set, and 3) data in a database representing vertical clearance of features and structures overlying an underlying roadway surface at multiple geographic locations along a travel route, to identify any feature or structure along the travel route whose vertical clearance to an underlying roadway surface is insufficient to assure passage of the vehicle underneath the feature or structure without collision of the vehicle with the feature or structure but which would enable sufficient clearance to be obtained if the ride height adjustment system were reset to a setting closer to the minimum limit of the range.

The present disclosure also relates to a method for avoiding collision of a vehicle, which has a ride height adjustment system and is traveling along a roadway, with a particular feature or structure which overlies an underlying roadway surface and has a known vertical clearance to the underlying roadway surface.

The method comprises: using a processor to evaluate 1) data representing a setting to which the ride height adjustment system was set while the vehicle was stationary, 2) for the setting to which the ride height adjustment system was set, data representing vertical distance from the highest point anywhere on the vehicle to an underlying roadway surface, and 3) data from a database representing vertical clearance from the particular feature or structure to the underlying roadway surface, to distinguish sufficient vertical clearance of the particular feature or structure to the underlying roadway surface from insufficient vertical clearance of the particular feature or structure to the underlying roadway surface; and when the evaluation discloses that the vertical clearance is insufficient to assure passage of the vehicle underneath the particular feature or structure without collision with the particular feature or structure but would enable sufficient vertical clearance to be obtained if the ride height adjustment system were reset to a setting closer to the minimum limit of the range, operating the ride height adjustment system to reset the ride height adjustment system in a direction toward the minimum limit of the range to a setting which assures passage of the vehicle underneath the feature or structure without collision of the vehicle with the feature or structure.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a left side elevation view of a highway tractor.

FIG. 2 is a left side elevation view of the highway tractor including a cargo trailer which is coupled to the tractor for towing by the tractor.

FIG. 3 is a fragmentary side elevation view of a portion of a ride height adjustment system.

FIG. 4 is a schematic diagram of the ride height adjustment system.

FIG. 5 is a map of a roadway including overpasses spanning the roadway.

FIG. 6 is an enlarged vertical view in the direction of arrow 6 in FIG. 5.

FIG. 7 is a schematic diagram of a control system for the ride height adjustment system.

FIG. 8 is a vertical cross section view through a drive axle looking in a direction lengthwise of the tractor.

### DETAILED DESCRIPTION

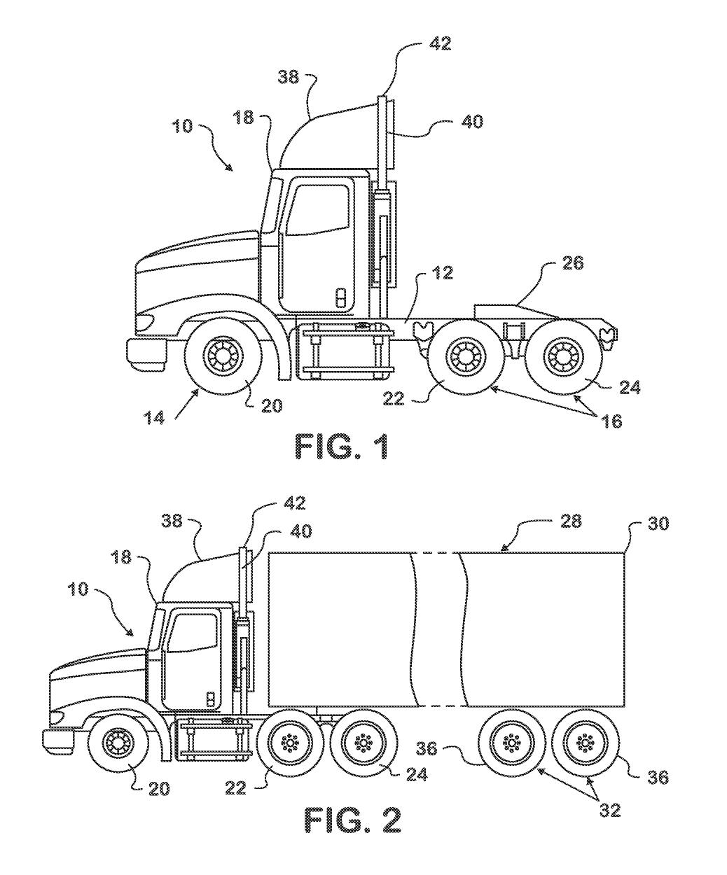

FIG. 1 shows an example of a highway tractor 10 which has a tractor chassis frame 12, a front axle group 14 and a rear axle group 16 both suspended from chassis frame 12 by respective suspensions, and a cab 18 mounted on chassis frame 12. Front axle group 14 comprises right and left front steered road wheels 20 (only the left can be seen in the Fig.) for steering tractor 10. Rear axle group 16 is a tandem drive axle which comprises right and left rear dual road wheels 22 at ends of the forward drive axle and right and left rear dual road wheels 24 at ends of the rearward drive axle. The tandem drive axle is coupled to an engine-driven powertrain for propelling highway tractor 10 on a roadway. Other possible embodiments for rear axle group 16, such as a single drive axle with or without a tag axle, are not illustrated.

A fifth wheel 26 supported on chassis frame 12 rearward of cab 18 provides for a trailer 28 (FIG. 2) to be connected to tractor 10 for towing by the tractor. The connection is made by a coupling which comprises a kingpin of trailer 28 which locks to fifth wheel 26. The coupling allows trailer 28 to swing horizontally with respect to tractor 10 about a vertical axis over a range of articulation angles. A portion of the trailer's weight is borne by fifth wheel 26 and that portion of the trailer's weight is ultimately transmitted through chassis frame 12, the suspension of rear axle group 16 and the rear axle group to the underlying road surface.

Trailer 28 comprises a trailer chassis frame on which a trailer body 30 is mounted. A trailer rear axle group 32 underneath the rear of trailer 28 is suspended from the trailer chassis frame. The portion of the trailer's weight not borne by fifth wheel 26 is transmitted through trailer rear axle group 32 and its suspension from the trailer chassis frame to the underlying road surface. Trailer rear axle group 32 is representative of a rear bogey having tandem axles with right and left dual wheels 36 at the ends of each axle. Other possible embodiments for trailer rear axle group 32 are not illustrated.

The portion of the trailer's weight which is borne by tractor 10 is borne at a location over the tractor's rear axle group 16. The greater that weight, the more the underlying suspension is flexed and the ride height reduced. A ride height adjustment system associated with the rear drive axle can set the ride height to counter, either in whole or in part, the reduction in ride height caused by the portion of the trailer weight borne by the tractor.

Trailer body 30 is a closed cargo body which has an interior floor bounded by upright right and left side walls and an upright front wall. The trailer interior is covered by a roof which is fastened to the upright walls. Access to the trailer body interior is provided by double doors at the rear which can swing open and closed.

A gap exists between the front wall of trailer body 30 and a rear wall of tractor cab 18. When the tractor-trailer is traveling on a roadway, a deflector 38 mounted on the roof of cab 18 can reduce aerodynamic drag by directing flow of ram air over the gap and along the trailer roof.

Tractor also has a vertical exhaust pipe 40 on the exterior of cab 18 through which engine exhaust is conveyed to an outlet 42.

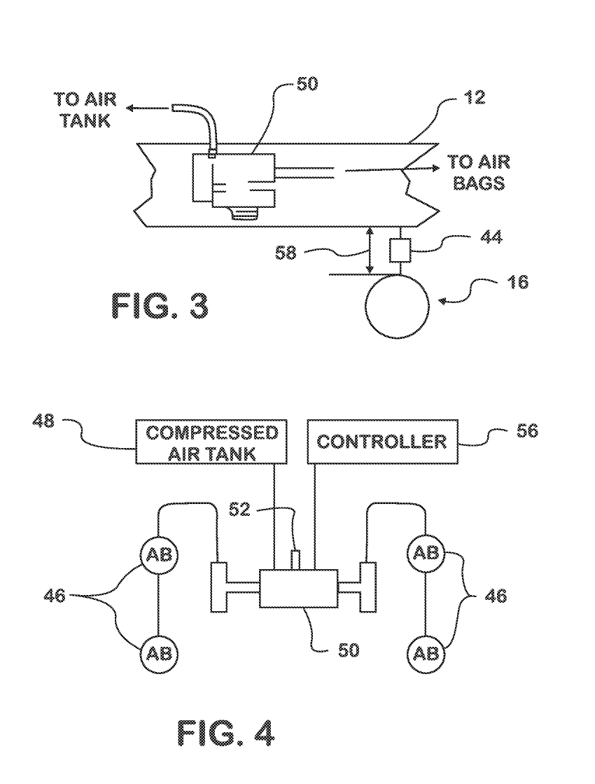

FIGS. 3 and 4 illustrate a ride height adjustment system 44 which is associated with the suspension of rear axle group 16 from chassis frame 12. Adjustment system 44 comprises multiple air (pneumatic) bags 46 shown in FIG. 4. Ride height is increased by filling the air bags with compressed air from a compressed air tank 48 via a control valve 50 and is decreased by venting compressed air from the air bags via a vent 52. A ride height sensor 54 (FIG. 7) is associated with adjustment system 44 to measure ride height. The measurement is used by a controller 56 (also shown in FIG. 7) to accurately set ride height to a desired ride height within a range of ride heights extending from a minimum limit to a maximum limit.

FIG. 3 illustrates a commonly accepted definition of vehicle ride height as vertical distance 58 between chassis frame 12 and an axle of rear axle group 16 which is suspended from chassis frame 12 by air bags 46. A desired ride height is set by controller 56 (to be more fully explained in description of FIG. 7) which may include a driver input which enables a driver of tractor 10 to set a desired ride height. Controller 56 also includes a capability for automatic setting of ride height.

As mentioned earlier, the disclosed system and method use ride height adjustment system 44 in conjunction with data representing vertical distance from the highest point on a vehicle (the vehicle being the tractor-trailer combination in the example illustrated) to an underlying road surface and data in a data base of vertical clearances of geographic features, or structures such as overpasses and tunnels, to an underlying road surface along a roadway to identify those features and structures which provide sufficient clearance to assure that the vehicle can pass under or through without colliding with the overlying feature or structure and to identify features and structures which do not provide sufficient clearance.

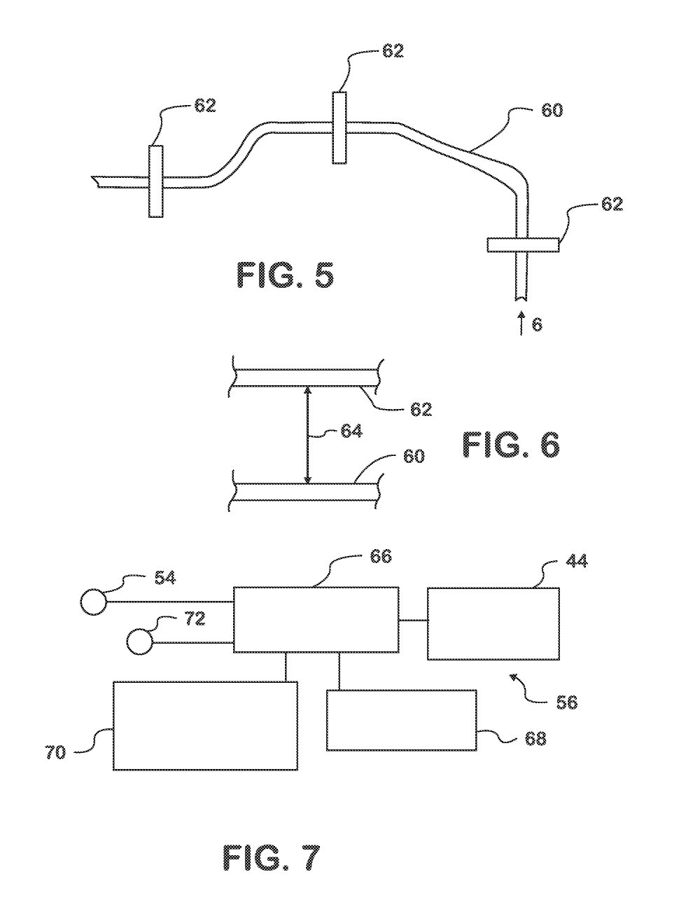

FIG. 5 depicts a roadway 60 and several overpasses, or bridges, 62 which span the roadway at various geographic locations. Each overpass 62 provides a certain vertical clearance 64 to an underlying surface of roadway 60 as shown in FIG. 6.

Controller 56 comprises an on-board processor 66 which evaluates vertical distance from the highest point on tractor-trailer 10, 28 to the underlying roadway surface with respect to vertical clearance at each overpass 62 beneath which the tractor-trailer will pass during travel along a defined travel route on the roadway. Because the height of the highest point on the tractor-trailer above the underlying roadway surface is a function of the particular ride height setting to which ride height adjustment system 44 is set, processor 66 also takes the measurement of the ride height setting into account. The measurement is taken when the vehicle is stationary and tires of the road wheels are inflated to a selected inflation pressure.

If a particular overpass 62 is found to provide insufficient clearance and the particular setting of ride height adjustment system 44 would allow further reduction in ride height setting in a direction toward the minimum limit, it becomes possible to determine if the available reduction in ride height is sufficient to assure that the tractor-trailer can pass under the particular overpass without collision. If so, ride height is readjusted in a direction toward the minimum limit in an appropriate amount and the original travel route need not be modified to avoid that particular overpass; otherwise an alternate travel route which bypasses it can be chosen. If the ride height is reduced to maintain the original travel route, the ride height adjustment system may be readjusted in a direction toward the maximum limit after the tractor-trailer has passed through the particular overpass. Ride height adjustment may be made automatically by controller 56 based on location of the vehicle as determined by a GPS sensor.

The highest point on the trailer-trailer to an underlying road surface may be either on tractor 10 or on trailer 28. Even the roof of cab 18 may not necessarily contain the highest point on the tractor. For example, devices or equipment mounted on the roof, such as deflector 38, or vertical exhaust pipe 40 on the exterior of cab 18, may extend higher than the cab roof. The trailing edge of deflector 38 may extend higher than the leading edge of the roof of trailer 28, or alternately, the leading edge of the trailer roof may extend higher.

Hence the configuration and dimensional parameters of a particular tractor and those of a particular trailer are used to identify the highest point on either tractor or trailer. Once the highest point has been identified, its vertical distance from the underlying road surface is determined by calculation or by actual measurement for a given setting of ride height adjustment system 44 and a given tire inflation pressure.

Controller 56 has data storage 68 for vehicle parametric data not only about tractor 10 but also about various trailers which may be coupled to the tractor. When a particular trailer is coupled to the tractor, processor 56 evaluates the tractor-trailer configuration and data parameters of both tractor and trailer to determine their highest point and then uses the distance of that point above the underlying road surface in the processing described above. Controller 56 also has data storage 70 for travel route data including overpass locations and their height clearances. A GPS sensor 72 provides vehicle location data along a roadway and can enable automatic ride height adjustment as mentioned above. Alternately, a driver of the vehicle can use GPS data and overpass clearance data to make ride height readjustment by a driver-operated input.

While FIG. 7 shows controller 56 on-board tractor 10, all or part of the processing may be performed at a site which is remote from the tractor-trailer and with which the tractor-trailer has bi-directional wireless communication.

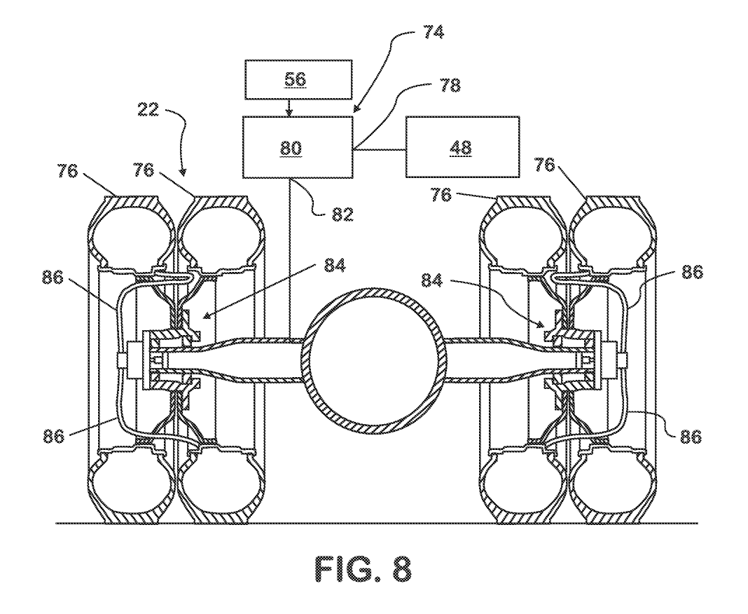

Vehicle ride height can be set in other ways which are in substitution of, or addition to, the one just described. One of those other ways is described with reference to FIG. 8 which shows an axle of rear axle group 16 and an on-board deflation/inflation system 74 for pneumatic tires 76 of right and left rear dual road wheels 22 at ends of the forward drive axle and for pneumatic tires of right and left rear dual road wheels 24 at ends of the rearward drive axle although only the forward axle is shown in FIG. 8. It should be understood that the axle's dual wheels are shown merely as one example, a different example being a single right wheel having a single wide base tire and a single left wheel having a single wide base tire. Ride height of any particular vehicle and any particular tires may be varied by varying tire inflation pressure, or by varying suspension air bag pressure, or by both, depending on the particular ride height control equipment on-board a vehicle. On-board tire inflation/deflation systems are known in the industry.

An inlet 78 of a control valve 80 is connected to compressed air tank 48 and an outlet 82 of control valve 80 is connected through leak-proof joints 84 and air conduits 86 to the interior of each tire 76, the tires being sealed to wheel rims in the usual fashion. Control valve 80 is controlled by controller 56 to set pressure in the tires in the same manner as the controller controls inflation and deflation of air bags 46. The respective valves 50, 80 may be controlled independently of each other or conjunctively with each other. Decreasing tire pressure lowers vehicle ride height while increasing tire pressure increases vehicle ride height.

Outlet 82 can be communicated to joints 84 via a leak-proof interior of the housing of the axle or via separate air lines directly to the joints.

In general, the range of ride height adjustment provided by tire pressure control is likely to be smaller than the range provided by suspension air bag pressure control, but the ranges should for the most part be additive.

What is claimed is:

1. A vehicle comprising:
a chassis frame;
road wheels on which the vehicle travels along an underlying roadway surface;
suspensions which suspend the road wheels from the chassis frame;
a ride height adjustment system for setting vertical distance from the chassis frame to an underlying roadway surface to a setting within a range of settings extending from a minimum limit to a maximum limit;
a controller for operating the ride height adjustment system to a setting within the range; and
a processor which evaluates: 1) data representing a setting to which the ride height adjustment system was set while the vehicle was stationary, 2) data representing vertical distance from the highest point anywhere on the vehicle to an underlying roadway surface for the setting to which the ride height adjustment system was set, and 3) data in a database representing vertical clearance of features and structures overlying an underlying roadway surface at multiple geographic locations along a travel route, to identify any feature or structure along the travel route whose vertical clearance to an underlying roadway surface is insufficient to assure passage of the vehicle underneath the feature or structure without collision of the vehicle with the feature or structure but which would enable sufficient clearance to be obtained if the ride height adjustment system were reset to a setting closer to the minimum limit of the range.

2. The vehicle as set forth in claim 1 in which the vehicle comprises a tractor having a rear drive axle group which contains some of the road wheels for propelling the tractor and which is suspended from the chassis frame by a suspension which contains the ride height adjustment system.

3. The vehicle as set forth in claim 2 in which the ride height adjustment system comprises deflatable/inflatable pneumatic bags and a controller for changing the setting of the ride height adjustment system by selectively deflating and inflating the pneumatic bags.

4. The vehicle as set forth in claim 3 in which the rear drive axle group has deflatable/inflatable pneumatic tires on road wheels at ends of an axle, and the ride height adjustment system further comprises a controller for changing the setting of the ride height adjustment system by selectively deflating and inflating the pneumatic tires.

5. The vehicle as set forth in claim 2 in which the tractor comprises a fifth wheel which is supported on the chassis frame, and the vehicle further comprises a trailer which is coupled to the tractor's fifth wheel for towing by the tractor and a portion of whose weight is borne by the fifth wheel.

6. The vehicle as set forth in claim 5 in which the data base is stored in data storage on-board the tractor.

7. The vehicle as set forth in claim 5 in which the data base is stored in data storage remote from the tractor, and is accessible to the tractor via wireless communication.

8. The vehicle as set forth in claim 2 in which the tractor comprises a GPS sensor which gives location of the tractor along a roadway in advance of a particular feature or structure identified as having insufficient vertical clearance to assure passage of the tractor-trailer underneath the feature or structure without collision of the vehicle with the feature or structure, and the controller is operable in advance of the particular feature or structure to readjust the ride height adjustment system in a direction toward the minimum limit to enable the tractor-trailer to pass under the feature or structure without colliding with the feature or structure.

9. The vehicle as set forth in claim 8 in which the controller is operable after the GPS sensor has disclosed that the tractor-trailer has traveled past the particular feature or structure to readjust the ride height adjustment system in a direction toward the maximum limit.

10. The vehicle as set forth in claim 1 in which the vehicle comprises a tractor having a rear drive axle group which contains some of the road wheels for propelling the tractor, the rear drive axle group has deflatable/inflatable pneumatic tires on road wheels at ends of an axle, and the ride height adjustment system comprises a controller for changing the setting of the ride height adjustment system by selectively deflating and inflating the pneumatic tires.

11. The vehicle as set forth in claim 10 in which the tractor comprises a fifth wheel which is supported on the chassis frame, and the vehicle further comprises a trailer which is coupled to the tractor's fifth wheel for towing by the tractor and a portion of whose weight is borne by the fifth wheel.

12. A method for avoiding collision of a vehicle, which has a ride height adjustment system and is traveling along a roadway, with a particular feature or structure which overlies an underlying roadway surface and has a known vertical clearance to the underlying roadway surface, the method comprising:
using a processor to evaluate 1) data representing a setting to which the ride height adjustment system was set while the vehicle was stationary, 2) for the setting to which the ride height adjustment system was set, data representing vertical distance from the highest point anywhere on the vehicle to an underlying roadway surface, and 3) data from a database representing vertical clearance from the particular feature or structure to the underlying roadway surface, to distinguish sufficient vertical clearance of the particular feature or structure to the underlying roadway surface from insufficient vertical clearance of the particular feature or structure to the underlying roadway surface; and
when the evaluation discloses that the vertical clearance is insufficient to assure passage of the vehicle underneath the particular feature or structure without collision with the particular feature or structure but would enable sufficient vertical clearance to be obtained if the ride height adjustment system were reset to a setting closer to the minimum limit of the range, operating the ride height adjustment system to reset the ride height adjustment system in a direction toward the minimum limit of the range to a setting which assures passage of the vehicle underneath the particular feature or structure without collision of the vehicle with the particular feature or structure.

13. The method as set forth in claim 12 further comprising operating the ride height adjustment system to reset the ride height adjustment system in a direction toward the maximum limit of the range after the vehicle has traveled past the particular feature or structure.

14. The method as set forth in claim 12 in which operating the ride height adjustment system to reset the ride height adjustment system in a direction toward the minimum limit of the range to a setting which assures passage of the vehicle underneath the particular feature or structure without collision of the vehicle with the particular feature or structure comprises deflating pneumatic bags in a suspension of the vehicle.

15. The method as set forth in claim 12 in which operating the ride height adjustment system to reset the ride height adjustment system in a direction toward the minimum limit of the range to a setting which assures passage of the vehicle underneath the particular feature or structure without collision of the vehicle with the particular feature or structure comprises deflating pneumatic tires of road wheels at ends of an axle of the vehicle.
